(19) United States
(12) Patent Application Publication
(10) Pub. No.: US 2016/0330266 A1
(43) Pub. Date: Nov. 10, 2016

(54) REMOTELY CONTROLLING A DEVICE VIA A WEB BROWSER

(71) Applicant: YANDEX EUROPE AG, Luzern (CH)

(72) Inventor: Viacheslav Arturovich BAKHMUTOV, Kemerovo Region, Novokuznetsk (RU)

(21) Appl. No.: 15/110,269

(22) PCT Filed: Dec. 16, 2014
(86) PCT No.: PCT/IB2014/066973

§ 371 Date: Jul. 7, 2016

(30) Foreign Application Priority Data
Apr. 9, 2014 (RU) 2014113964

(51) Int. Cl. H04L 29/08; H04L 29/06

(52) U.S. Cl. CPC H04L 67/025; H04L 67/40; H04L 67/20; H04L 67/104; H04L 65/608

(57) ABSTRACT

Disclosed are system and method for remotely controlling a user device via a web browser. An example method includes accessing, via a web browser of a first user device, a third-party web page that provides a web API configured to perform remote control commands on one or more second user devices. The method further includes obtaining, via the web API information about at least one second user devices associated with the first user device and one or more remote control commands supported by a web browser of the second user device. The method further includes receiving, via the web API, a remote control command that instructs a web browser of a second user device to perform a function associated with the remote control command and transmitting the remote control command to the web browser of the second user device to perform the function on the second user device.

### CROSS-REFERENCE

The present application claims convention priority to Russian Patent Application No. 2014113964, filed Apr. 9, 2014, entitled “SYSTEM AND METHOD FOR REMOTELY CONTROLLING A DEVICE VIA A WEB BROWSER” which is incorporated by reference herein in its entirety.

### TECHNICAL FIELD

The disclosure relates generally to the field of remote communication of devices, and more specifically to the systems, methods and computer program products for providing remote control of a device via a web browser.

### BACKGROUND

Remote access, management, and administration of personal computers and other electronic devices involves using one device to securely control another device through the Internet. Typically, access to a remote device requires the use of a specific software (e.g., Internet browser) or an operating system feature that allows a personal computer's desktop environment to be run remotely on one device while being displayed on a separate device.

Remote desktop applications have varying features. Some allow attaching to an existing user's session (i.e., a running desktop) and remotely controlling the user's session. Generally, remote access is used for scenarios such as ad hoc remote support and remote access to personal applications and files. The current remote desktop applications and web services, however, do not provide an efficient, platform independent mechanism for remotely controlling a device from various third-party websites using a web browser. Therefore, there exists an unmet need in the art for systems and methods for providing remote control of a device (e.g., personal computer, mobile phone) via a web browser.

### SUMMARY

Disclosed are systems, methods and computer program products for providing remote control of a device via a web browser. According to one aspect, an example method includes accessing, via a web browser of a first user device, a third-party web page that provides a web application program interface (API) configured to perform remote control commands on one or more second user devices. The method further includes obtaining, via the web API, from a sync server, information about at least one second user devices associated with the first user device and one or more remote control commands supported by a web browser of the second user device. The method further includes receiving, via the web API, a remote control command that instructs a web browser of a second user device to perform a function associated with the remote control command. The method further includes transmitting, via the web API, the selected remote control command to the web browser of the second user device to perform the function on the second user device.

In another aspect, an example method includes registering a first user device with a sync server. The registering may include associating the user device with a user profile on the sync server. The method further includes synchronizing the first user device with the sync server. The synchronization may include providing to the sync server information about configuration of the first user device. The method further includes accessing via a web browser of the user device, a third-party web page that that provides a web API configured to perform remote control commands on one or more second registered user devices. The method further includes selecting, via the web API, a remote control command that instructs a web browser of a second registered user device associated with the user profile to perform a function associated with the specified remote control command on the second user device. The method further includes transmitting, via the web API, the selected remote control command to the web browser of the second user device to perform the function on the second user device. In one example, the web API includes a library of API functions provided by the web browser of the first user device.

In another example, the web API includes a library of API functions provided by the sync server or a web service server.

In another example, the web API may be configured to generate a user interface component in the web browser of the first user device; and detect activation of the user interface component by the user within the web browser of the first user device.

In another example, the user interface component may be configured to display a list of remote control commands for selection by a user of the first user device.

In another example, the user interface component may be configured to display a list of registered user devices capable of performing the remote control command.

In another example, the configuration information may include information about functions that can be performed by the first browser of the first user device.

The above simplified summary of example aspects serves to provide a basic understanding of the invention. This summary is not an extensive overview of all contemplated aspects, and is intended to neither identify key or critical elements of all aspects nor delineate the scope of any or all aspects of the invention. Its sole purpose is to present one or more aspects in a simplified form as a prelude to the more detailed description of the invention that follows. To the accomplishment of the foregoing, the one or more aspects of the invention include the features described and particularly pointed out in the claims.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations.

FIG. 1 is a diagram illustrating an example aspect of a system for providing remote control of a device via a web browser according to one aspect of the invention.

FIG. 2 is a flow diagram illustrating an example method for providing remote control of a device via a web browser according to one aspect of the invention.

FIG. 3 is a flow diagram illustrating an example method for providing remote control of a device via a web browser according to one aspect of the invention.

FIG. 4 is a flow diagram illustrating an example method for providing remote control of a device via a web browser according to one aspect of the invention.

FIG. 5 is a diagram illustrating an example aspect of a general-purpose computer system on which are implemented the systems and methods for providing remote control of a device via a web browser in accordance with aspects of the invention.

### DETAILED DESCRIPTION

Example aspects of the present invention are described herein in the context of systems, methods and computer program products for providing remote control of a device via a web browser. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same items.

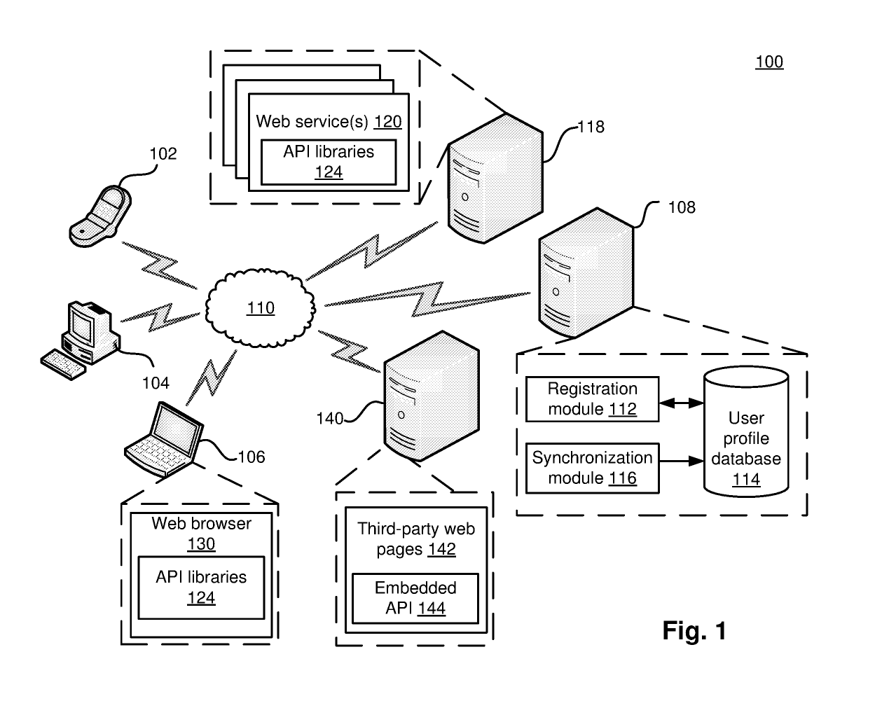

FIG. 1 depicts an example system 100 for providing remote control of a device via a web browser according to one aspect of the invention. The system 100 may include various electronic user devices, such as a mobile device 102 (e.g., a tablet or a smart phone with web browsing capability), a desktop computer 104, and a laptop 106. The devices 102, 104, 106 may be connected to a network 110, such as the Internet, via a wired or wireless connection. Also connected to the network 110 may be a sync server 108 and a web service server 118. In various aspect, the servers 108 and 118 and may be implemented on a same or different hardware servers and may be hosted by the same or different parties. In one aspect, the web server 118 that may host one or more web services 120 that provides one or more libraries of application program interfaces (API) functions 124 for remote control of various user devices 102, 104, 106 by, for example, receiving and transmitting remote control commands, instructions, or other information from and to devices 102, 104, 106. In one aspect, the sync server 108 may include a registration module 112, a synchronization module 116 and a user profile database 114. The functionality of each of these modules of the sync server 108 will be described in greater detail below. The system may further include a third-party web server 140 that host a plurality of third-party websites, which include web pages 140. The web pages 140 may include embedded API function calls 134 associated with library of API functions 124.

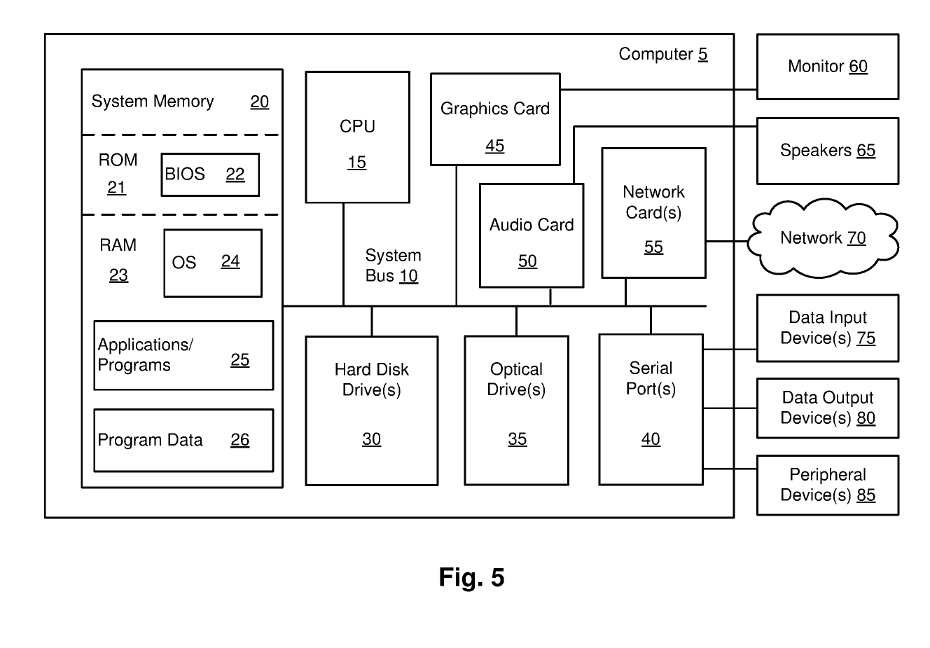

The term “module” as used herein means a real-world device, apparatus, or arrangement of modules implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 5 below). Accordingly, each module can be realized in a variety of suitable configurations, and should not be limited to any particular implementation exemplified herein.

In one example, each of the user devices 102, 104, 106 shown in FIG. 1 may include web browsers 130 that allows a user to retrieve, peruse, and navigate information resources on the World Wide Web via the network 110. The web browser may be any type of web browser that supports API, such as Yandex browser, Google Chrome, Mozilla Firefox, Internet Explorer, Opera, and Safari. A user of the devices 102, 104, 106 may register each of the devices via the devices' respective web browser 130 with the sync server 108. The user may initiate registration of a device, such as mobile device 102, by, for example, using the web browser of the device 102 to navigate to a registration web site of the sync server 108. The registration module 112 of the sync server 108 may prompt the user to register a user identity and the device 102 by requesting various identifying user profile information, such as name, e-mail, address, and login information, such as username and password. The registration module 112 may also automatically detect and include in the user's profile information any identifying features of the device 102 and web browser 130 from which the user is accessing the registration web site. Once the registration module 112 obtains all of the relevant user profile information for the particular user and device, the registration module 112 may store the user profile information in the user profile database 114. If the user wishes to register an additional device, such as desktop computer 104, the user may use the web browser on the device 104 to access the registration web page, and add the device 104 to the already existing user profile information of that user, such that both devices 102 and 104 are associated with the user. The user may similarly register and add any additional devices to the user's profile information.

Once the user devices 102, 104, 106 are registered with the sync server 118, the synchronization module 116 may be activated to synchronize the web browsers 130 of the devices 102, 104, 106 associate with a particular user profile. During the synchronization process, which may be performed every time a web browser of the used device is run by the user, the synchronization module 116 may collect from the registered user devices 102, 104, 106 information about their software and hardware configuration. Such information may include, but not limited to, operating system information, device properties information, web browser information, internal and peripheral hardware information, application information and other information. For example, operating system information may include, but not limited to, the OS version, the firmware version, drivers installed version etc.; the hardware information may include, but not limited to, vendor information, information of the device model, available peripherals (e.g., camera, wireless module (e.g., GSM), location module (e.g., GPS), accelerometer, compass, etc.); device properties information may include, but not limited to, display resolution, memory, CPU info, GPU info, etc.; browser information may include but not limited to, browser engine model/name (e.g., webkit, gekko, trident), version, supported features of HTML5 and JS; and application information may include information about specific application deployed on the user devices, such as for e-mail application, the information may include, for example might provide some information about email account providers.

In one example, during synchronization, the browsers 130 may transmit to the sync server 108 information about functions that may be performed by the browser (e.g., print, e-mail, display on screen, continue video stream, activate camera). The sync server 108 makes the collected information available to all other registered devices associated with the same user profile. In one aspect, this information may be used for remote control of one user device via the web browser of another device, as will be discussed in greater detail below.

Once the user and the user's associated devices 102, 104, 106 are registered and synchronized by the sync server 108, the user may now be able to use the web browser 130 of one of the devices 102, 104, 106 to control the web browser and any browser-controlled operations of any of the other devices 102, 104, 106, including for example, operating system services, software applications and various internal and peripheral devices. For example, the user may use the web browser of the mobile device 102 to control the web browser of the desktop computer 104. In one aspect, such control may be facilitated by a remote control web service 120 provided by the service server 118. Particularly, the web service 120 may provide libraries of API functions 124, which includes a plurality of API functions that facilitate remote browser control. Following are example of remote browser control API functions 124:

Api.getDevice( )—provides general information about devices synchronized with this account. For example, the information can contain an account name (e.g., Sam@yandex.com).

Api.getDevice(device)—provides full information about user associated devices.

Api.send(device, data)—used to send data to another device/application. For example, API.send (Device_104, image1.jpg).

Api.receive(device, callback)—used to receive data from another device/application. For example, the receive-message can contain API.receive (Device_104, image1.jpg)

Api.push(device, message, data)—used to send push message to another device. For example, API.push (Device_104, command to send a document to print, the document itself).

In one example, the libraries of remote browser control web API functions 124 may be implemented as server-side API functions provide by the Web services servicer 120. In another example, the libraries of remote browser control web API functions 124 may be implemented as client-side API functions provided by the browser 130 (e.g., browser add-on, browser app, extension) of any of the user devices 102, 104, 106.

In one example, the remote control web API functions 124 may be called using API function calls 144 embedded in third-party web pages 144 hosted by the third-party web server 140. The third-party websites 144 may include, but not limited to, online retail websites, banking websites, news websites, video streaming websites, travel booking websites, etc. The API function calls 144 may be embedded using HTML or JavaScript into code of the web pages 142 by website developers or web hosting service providers. In this manner, when a browser 130 of the user device 106 accessed a third party web page 142 from the web server 140, which includes an embedded remote control API function call 144, the web browser 130 executes the embedded API function call 144, which in turn executes the associated remote control web API function 124 provided by the web browser 130, or requests the web service 120 to perform the remote control functionality specified in the API function call 144. In one example, using the API functions 124, a web browser 130 of the user device 106 may use web services 120 hosted on the web service server 118 to establish a connection with a browser of another user device, e.g., device 104, and to perform a remote control command using the web browser of the user device 104. In another example, the web browser 130 of the user device 106 may use API functions 124 to establish direct P2P connection with the user device 104 and to request the web browser on the user device 104 to perform requested remote control functions.

An example scenario of operation of the system 100 for providing remote control of a device via a web browser of another device is illustrated below. For example, a user may activate a web browser of a mobile device 102 and a web browser of a PC 104. Once activated, the browsers may automatically register and synchronize with the sync service 108. During synchronization, each browser may provide to the sync server 108 information about functions that the browser can perform on the user device. The user may then visit some third-party website 142 using the web browser 130 of mobile device 102. If the visited website 142 includes pages with embedded remote control web API function calls, the user may activate the remote control web API functions 124, by clicking an icon or some other user interface component associated with the browser control web API 124. The icon may, for example, be located in a corner of the browser window or embedded in the code of the accessed web page 142. The user may activate the browser control web API 124 by, for example, clicking or tapping on the icon, or dragging and dropping an object, such as a file or folder, onto the icon, and so on.

Once the remote control web API 124 is activated, it may request the sync server 108 to provide information from the user profile database 114 about available registered user devices (e.g., PC 104) and functions that browsers of the registered devices can perform. The received information may be displayed to the user via a drop down menu or check boxes or any other convenient selection format. The commands may include a number of functions that the user may choose to instruct a target web browser of PC 104 to execute. The functions, for example, may include print, e-mail, display on screen, continue video stream, activate camera, and any other functions within the capability of the target web browser to execute.

After the user selects the target device PC 104 and a function to be performed remotely on the device 104, the web browser of the originating mobile device 102 transmits, via the web API functions 124, to the remote control web service 120 of web server 118 a remote control command, which may include the target device selection, the function selection, and any necessary user identifier information, such as, a hash of the originating user device identifier and other information. The remote control web service 120 may in turn transmit the received remote control command, via, for example, push technology, such as Apple Push Notification Service (APNS) or Google Cloud Messaging (GCM), to the web API functions of the browser of the PC 104, which will perform the function associated with the received remote control command. In various aspects, the transmissions between the mobile device 102, web service 120 and PC 104 may be implemented using, for example, a Hypertext Transfer Protocol Secure (HTTPS), an extension over HTTPS (e.g., web socket), or a Peer-to-Peer protocol (e.g., Web Real-Time Communication (WebRTC)). The web browser of the target device PC 104 may receive the remote control command and execute the function associated with the command. In this manner, the user may remotely control a web browser of a target device with a web browser of an originating device via the remote control web service 120.

For example, according to an aspect, the user may be reading a document using the web browser on the mobile device 102. If the user decides to print the document, the user may activate the web API in the web browser, select the print command and the desktop computer 104 as the target device. The web API may then push the command via the services server 118 to the web browser of the PC 104, which may then execute the command, i.e., print the document. In a similar manner, the user may add photos to websites within the web browser of the desktop computer 104 using a camera of the mobile device 102. As another example, the user may use the mobile device 102 to look at a location on a map, while using the desktop computer 104 to interact with a panoramic view of the same location.

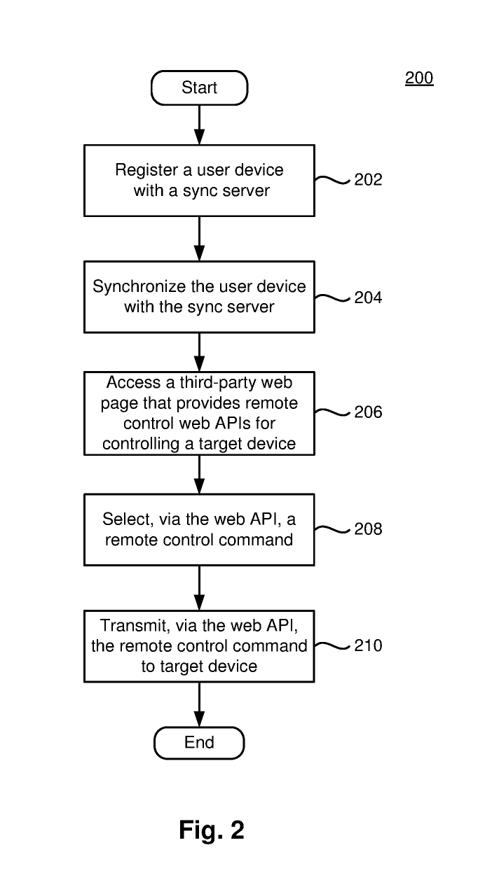

FIG. 2 is a flow diagram illustrating an example aspect of a method for providing remote control of a device via a web browser according to one aspect of the invention. The process described in this flow diagram may be implemented in a command-origination device, such as mobile device 102. As shown in FIG. 2, the process 200 may begin in block 202, where a user may register one or more user devices (e.g., mobile device 102 and PC 104) with the sync server 108. In block 204, the registered user devices (e.g., mobile device 102 and PC 104) may synchronize their web browsers with the sync server 108. In block 206, the user of the first device (e.g., mobile device 102) accesses, via a web browser of the user device, a third-party web page that provides remote control web application program interface (API) configured to perform remote control commands on one or more second user devices. The web API includes API function calls 144 to a library of API functions 142 that provide remote control of target user devices. In block 208, the user may select, via the web API, a remote control command. In block 310, the web API 124 may transmit the remote control command to the target device (e.g., PC 104).

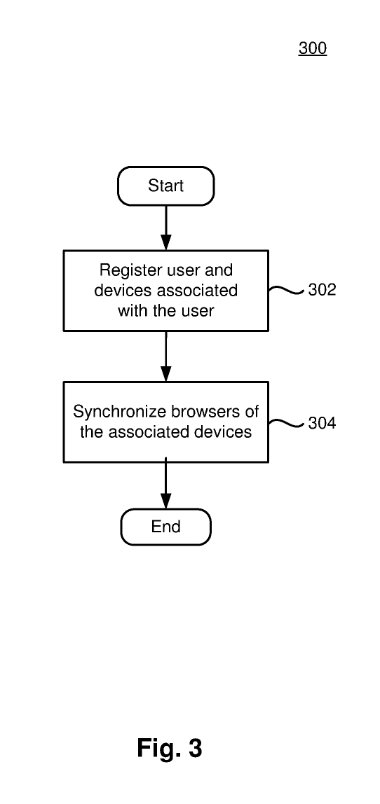

FIG. 3 is a flow diagram illustrating an example aspect of a method for providing remote control of a device via a web browser according to one aspect of the invention. The process described in this flow diagram may be implemented in the sync server 108. As shown in FIG. 3, the process 300 may begin in block 302, where a user and devices associated with a user may be registered. For example, a user may, via a registration module 112, register a user identity and any of the devices associated with the user identity in a user profile that is stored in the user profile database 114 of the sync server 108. In block 304, browsers of the associated user devices may be synchronized. For example, the synchronization module 116 of the sync server 108 may collect from the browsers of each registered user device the configuration information, including information about functions performed by the browser.

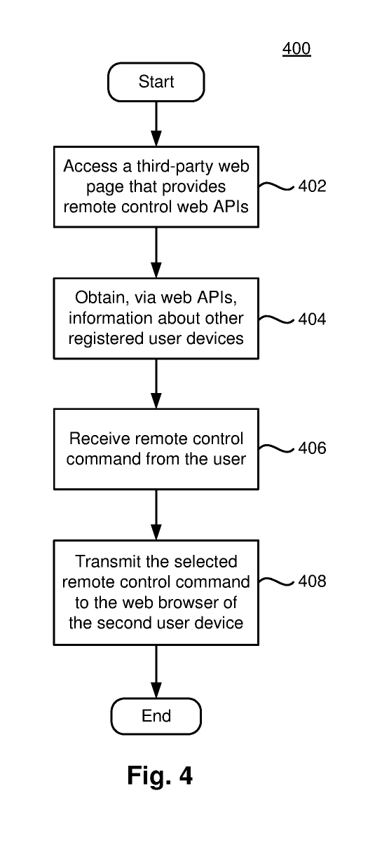

FIG. 4 is a flow diagram illustrating an example aspect of a method for providing remote control of a device via a web browser according to one aspect of the invention. The process described in this flow diagram may be implemented by a remote control web service 120 hosted by the service server 118. As shown in FIG. 4, the process 400 may begin in block 402, in which the user may activate, via a web browser of a first user device, a remote control web service 120. The web service 120 may be activated via one or more associated remote control API functions 124. In block 404, the remote control functions 124 may obtain from the sync server 108 information about at least one second user devices associated with the first user device and one or more remote control commands supported by a web browser of the second user device. In block 406, the web API functions 124 receive a remote control command from the user that instructs a web browser of a second user device to perform a function associated with the remote control command. At block 408, the web API functions 124 transmit the selected remote control command to the web browser of the second user device to perform the function on the second user device.

FIG. 5 depicts one example aspect of a computer system 5 that may be used to implement the disclosed systems and methods for providing remote control of a device via a web browser according to one aspect of the invention. The computer system 5 may include, but not limited to, a personal computer, a notebook, tablet computer, a smart phone, a mobile device, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the invention, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for remotely controlling a web browser, the method executable by a first user device coupled to a network, the method comprising:
transmitting over the network to a sync server a first request, the first request for registering the first user device with the sync server, by associating the user device with a first user profile;
transmitting first information about configuration of the first user device to the sync server, thereby synchronizing the first user device with the sync server, in response to a web browser of the first user device being activated;
accessing, by the web browser of the first user device, a third-party web page providing a web application program interface (API), the web API configured to generate a user interface component in the first user device web browser to display (i) a list of remote control commands for selection by a user of the first user device, and (ii) a list of one or more registered second user devices associated with the first user profile capable of performing each of the remote control command via a web browser of the second user device;
selecting, by the web browser of the first user device, the second user device and the remote control command to be performed by the web browser of the second user device;
establishing via the web API, a direct peer-to-peer connection between the web browser of the first user device and the web browser of the second user device; and,
transmitting, via the direct peer-to-peer connection, the selected remote control command to the second user device web browser to perform the remote control command.

2. The method of claim 1, wherein the web API includes a library of API functions provided by the web browser of the first user device.

3. The method of claim 1, wherein the web API includes a library of API functions provided by the sync server or a web service server.

4. The method of claim 1, wherein the web API is configured to:
detect activation of the user interface component by the user within the web browser of the first user device.

5.-6. (canceled)

7. The method of claim 1, wherein the information about configuration includes information about functions that can be performed by the web browser of the first user device.

8. A system for remotely controlling user device functions via a web browser, the system comprising:
a first user device coupled to a network, the first user device being configured to:
transmit over the network to a sync server a first request, the first request for registering the first user device with the sync server, by associating the user device with a first user profile;
transmit first information about configuration of the first user device to the sync server, thereby synchronizing the first user device with the sync server, in response to a web browser of the first user device being activated;
access, by the web browser of the first user device, a third party web page providing a web application program interface (API), the web API configured to generate a user interface component in the first user device web browser to display (i) a list of remote control commands for selection by a user of the first user device, and (ii) a list of one or more registered second user device associated with the first user profile capable of performing each of the remote control command via a web browser of the second user device;
select, by the web browser of the first user device, the second user device and the remote control command to be performed by the web browser of the second user device;
establishing via the web API, a direct peer-to-peer connection between the web browser of the first user device and the web browser of the second user device; and,
transmit, via the direct peer-to-peer connection, the selected remote control command to the second user device web browser to perform the remote control command.

9. The system of claim 8, wherein the web API includes a library of API functions provided by the web browser of the first user device.

10. The system of claim 8, wherein the web API includes a library of API functions provided by the sync server or a web service server.

11. The system of claim 8, wherein the web API is configured to:
detect activation of the user interface component by the user within the web browser of the first user device.

12.-13. (canceled)

14. The system of claim 8, wherein the information about configuration includes information about functions that can be performed by the web browser of the first user devices.

15.-21. (canceled)

22. A method for remotely controlling a web browser, the method executable by a first user device coupled to a network, the first user device having been registered with a sync server in association with a first user profile, the first user profile including first information about configuration of the first user device, the method comprising:
accessing, by the web browser of the first user device, a third party web page providing a web application program interface (API), which provides remote control commands executable by a synchronized second user device having been registered with the sync server and associated with the first user profile;
obtaining, by the web browser of the first user device via the web API, information about the synchronized second user device;
selecting, by the first user device browser via the web API, a remote control command to be performed by the second user device web browser;
establishing via the web API, a direct peer-to-peer connection between the web browser of the first user device and the web browser of the second user device; and,
transmitting, via the direct peer-to-peer connection, the selected remote control command to the second user device web browser to perform the remote control command.

23.-27. (canceled)

28. The method of claim 1, wherein the web API is operationally connectable to the web browser of the first user device, the web browser of the first user device configured to activate the web API.

29. The method of claim 28, wherein said activation causes the sync server to provide information about available registered second user devices associated with the first user profile.

30. The method of claim 29, wherein the web API is operationally connectable to the web browser of the selected second user device, the web browser of the selected second user device being configured to execute the remote control command.

31. The system of claim 8 wherein the web API is operationally connectable to the web browser of the first user device, the web browser of the first user device being configured to activate the web API.

32. The system of claim 31, wherein said activation causes the sync server to provide information about available registered second user devices associated with the first user profile.

33. The system of claim 32, wherein the web API is operationally connectable to the web browser of the selected second user device, the web browser of the selected second user device being configured to execute the remote control command.

34. The method of claim 1, wherein at least one of the web browser of the first user device and second user device is a conventional web browsing application.

35. The method of claim 1, wherein at least one of the web browser of the first user device and second user device is an application that is part of an operating system of the user device.

36. The system of claim 8, wherein at least one of the web browser of the first user device and second user device is a conventional web browsing application.
